(19) United States
(12) Patent Application Publication
(10) Pub. No.: US 2017/0001486 A1
(43) Pub. Date: Jan. 5, 2017

(54) TIRE REMOVING DEVICE

(71) Applicant: MING TSAI, Taichung City (TW)

(72) Inventor: MING TSAI, Taichung City (TW)

(21) Appl. No.: 15/104,055

(22) PCT Filed: Dec. 17, 2013
(86) PCT No.: PCT/CN2013/089649

§ 371 Date: Jun. 13, 2016

(51) Int. Cl. B60C 25/132; B60C 25/13

(52) U.S. Cl. CPC B60C 25/132; B60C 25/13

(57) ABSTRACT

A tire removing device, which is disposed on a wheel rim of a large vehicle for removing a tire, includes a seat provided with a first end and a second end, the first end movably clamping a wheel disk of the wheel rim; a power cylinder disposed on the second end of the seat and provided with a cylinder body and a moving shaft movable against the cylinder body; and a tire removable plate connected to an end of the moving shaft. When the power cylinder is put in operation, the tire removable plate pushes the inner edge of the tire, so as to remove the tire from the wheel rim.

### BACKGROUND OF THE INVENTION

1. Field of the Invention

The present invention relates to tire removing devices, and more particularly, to a tire removing device capable of removing tires of large vehicles.

2. Description of the Related Art

When tire puncture of current vehicle occurs on the road, a passenger car is usually provided with a spare tire, such that the spare tire is installed to facilitate further driving. As for large vehicles such as lorry or trucks, spare tire is seldom provided. Because tire maintenance is unable to be conducted at the roadside, the driver must contact automobile repair shop for supplying tire to the site, and the tire is replaced manually. Due to the large volume and heavy weight of the large vehicle tire, the tire maintenance is uneasy to be conducted and risks the traffic safety.

In the aforementioned manual tire maintenance, a spear is used to forcefully knock or prize the junction between the tire and the wheel rim, such that the periphery of the tire is slowly detached from the wheel rim, completing the tire removal. Such method is inconvenient, costing time and strength.

Also, in the industry, large tire removing machine is able to be disposed on a truck, so as to become a mobile tire removing equipment which is allowed to be immediately moved to the site where a tire removing operation is needed, thus eliminating the inconvenience of removing the tire manually. However, the cost of such tire removing machine is relatively high. In addition, the vehicle with punctured tires has to wait for the mechanic of the automobile repair shop who is contacted by the driver of the vehicle after the accident. Immediate operation is impossible; traffic on site is easily affected.

### SUMMARY OF THE INVENTION

For improving aforementioned issues, the present invention discloses a tire removing device which is provided with small volume, portability in vehicle, and tire removing efficiency.

Therefore, the present invention provides a tire removing device which is disposed on a wheel rim of a large vehicle for removing a tire thereof. The tire removing device comprises:

a seat provided with a first end and a second end, the first end movably clamping a wheel disk of the wheel rim;

a power cylinder disposed on the second end of the seat and provided with a cylinder body and a moving shaft movable against the cylinder body; and

a tire removable plate connected to an end of the moving shaft.

When the power cylinder is put in operation, the tire removable plate pushes the inner edge of the tire, so as to remove the tire from the wheel rim.

With such configuration, the tire removing device is advantageously provided with small volume and is allowed to be carried by a vehicle to meet a need in any time. When a tire of the vehicle is punctured, a fast replacement of the tire is provided, without the need of waiting for roadside assistance offered by automobile repair shops. Also, during the operation, the user is able to independently and less laboriously complete the tire replacing process.

### BRIEF DESCRIPTION OF THE DRAWINGS

FIG. 1 is a perspective view of the present invention.

FIG. 2 is an exploded view of the present invention.

FIG. 3 is a perspective view of the present invention disposed on the wheel rim.

FIG. 4 is a sectional view of the present invention disposed on the wheel rim.

FIG. 5 is an enlarged view of FIG. 4.

FIG. 6 is a schematic view illustrating the operation of the present invention.

FIG. 7 is another embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

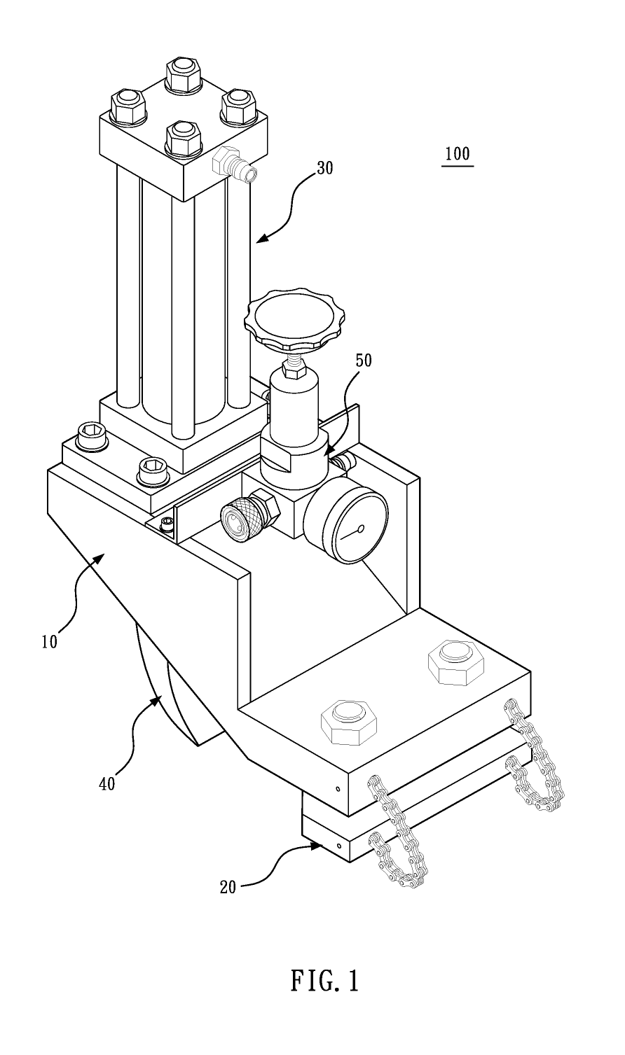

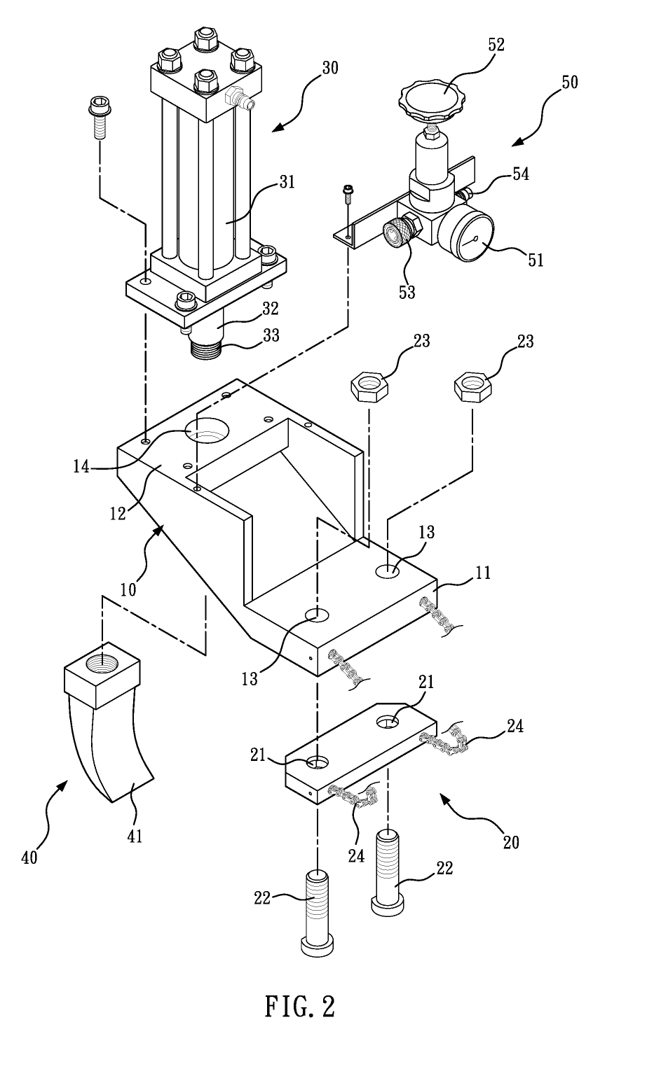

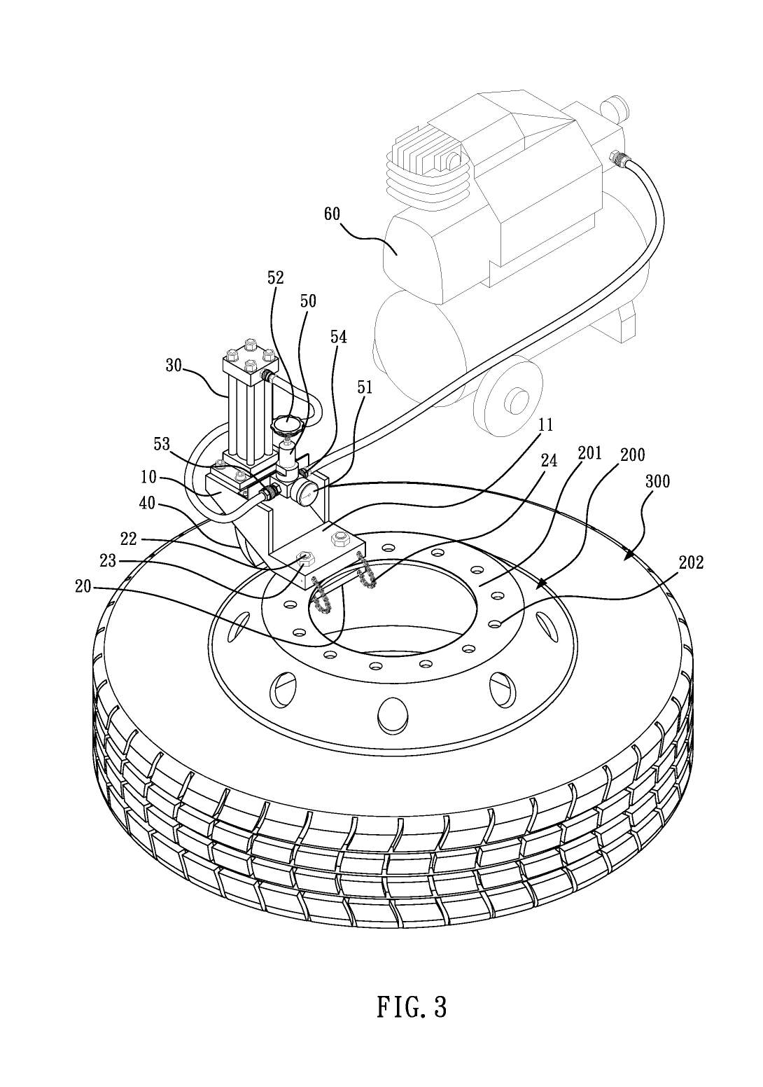

Referring to FIG. 1 to FIG. 3, a tire removing device 100 of the present invention is disposed on a wheel rim 200 of a large vehicle flatly placed on the ground, as shown by FIG. 3. The large vehicle includes a lorry or a truck. The wheel rim 200 is an iron made circle structure. When the tire removing device 100 is disposed on the wheel rim 200, the tire removing device 100 is able to remove a tire 300 mounted on the periphery of the wheel rim 200, especially a punctured tire 300. The tire removing device 100 comprises following elements.

A seat 10 is provided with a first end 11 and a second end 12. The first end 11 and the second end 12 are not disposed on the same horizontal plane; preferably, the second end 12 preferably is horizontally higher than the first end 11. The first end 11 has two bores 13. The second end 12 has a through hole 14.

A movable plate 20 is disposed on the first end 11 of the seat 10 for being fixed on a wheel disk 201 of the wheel rim 200 in a manner of clamping, as shown by FIG. 3. The movable plate 20 comprises with two combining holes 21 for two screw assemblies to pass through the combining holes 21 and the respective bores 13. Each screw assembly comprises a bolt 22 and a nut 23. The bolt 22 passes through the combining hole 21, a through bore 202 of the wheel disk 201 of the wheel rim 200 and the bore 13 to be screwed to the respective nut 23, such that the seat 10 and the movable plate 20 clamp to be fixed on the wheel disk 201. Furthermore, for facilitating the convenience of usage and preventing the movable plate 20 from lost, two connecting members 24 are disposed between the movable plate 20 and the first end 11 of the seat 10, preferably two chains for connecting the movable plate 20 to the seat 10.

A power cylinder 30 is fixed on the second end 12 of the seat 10. The power cylinder 30 is provided with a cylinder body 31 and a moving shaft 32 capable of extending against the cylinder body 31 and passing through the through hole 14. One end of the moving shaft 32 has a thread 33. Also, in the present invention, the power cylinder 30 is allowed to be a pneumatic cylinder.

A tire removing plate 40 is screwedly mounted on the thread 33 of the moving shaft 32 of the power cylinder 30, such that the tire removing plate 40 moves along the extending moving shaft 32. Also, the tire removing plate 40 has an arc end 41.

A pressure adjusting valve 50 is disposed between the first end 11 and the second end 12 of the seat 10. The pressure adjusting valve 50 is provided with a pressure gauge 51 and a pressure adjusting knob 52, and further comprises an outlet portion 53 and an inlet portion 54. The inlet portion 54 is allowed to be connected through a tube to a power source 60, which refers to an air compressor as shown in FIG. 3. The outlet portion 53 is allowed to be connected to the power cylinder 30 through another tube for controlling the outputting force of the power cylinder 30. When the power source 60 provides the power to the power cylinder 30, the power cylinder 30 provides the power for the tire 300 to move, such that the tire removing plate 40 is triggered to push the tire 300.

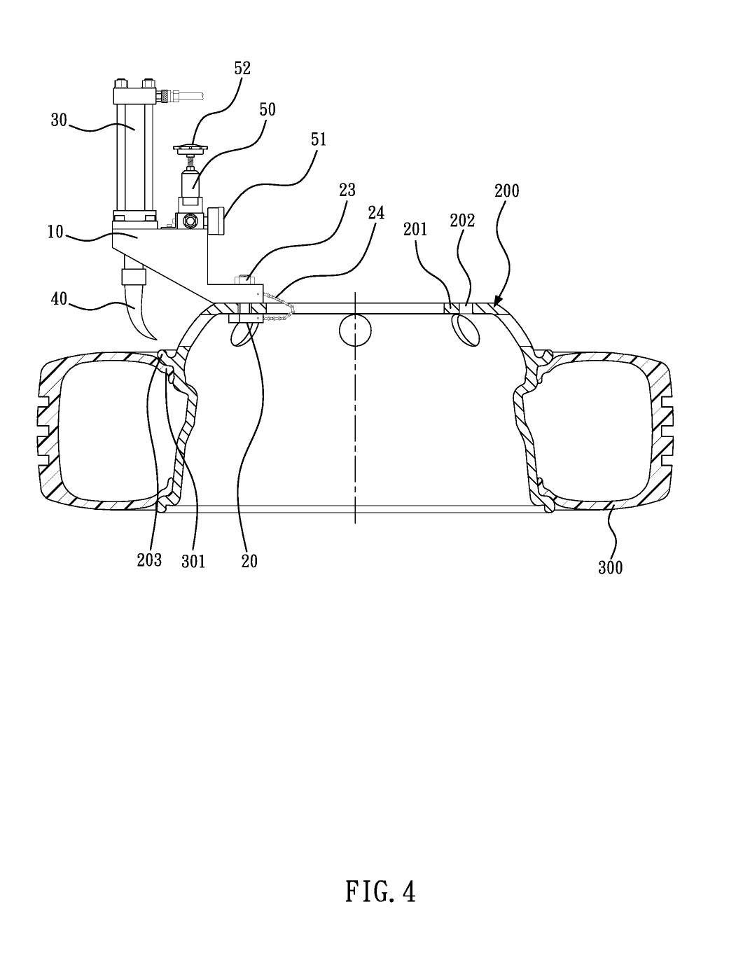

FIG. 4 is a sectional view of the tire removing device provided by the present invention which is disposed on the wheel rim. The seat 10 and the movable plate 20 are fixed on the wheel disk 201 of the wheel rim 200 in a manner of clamping. Also, due to the bolt 22 passing through the through bore 202 of the wheel disk 201 to be screwed to the nut 23, the seat 10 is stably fastened to the wheel disk 201. Because the two ends of the seat 10 are not on the same horizontal plane, a certain distance is maintained between the tire removing plate 40 and the tire 300.

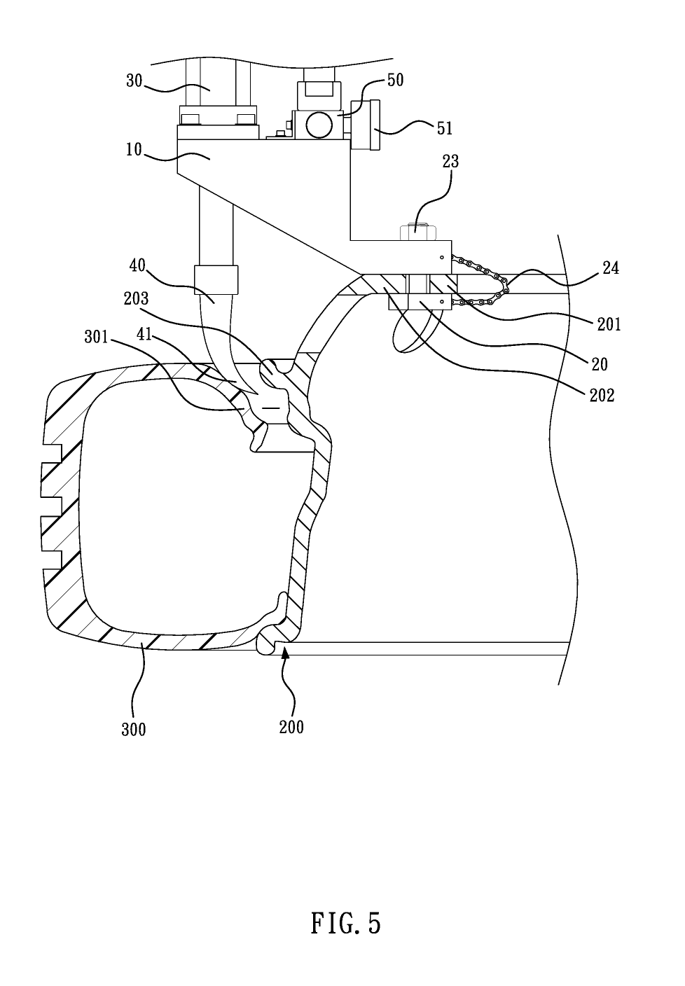

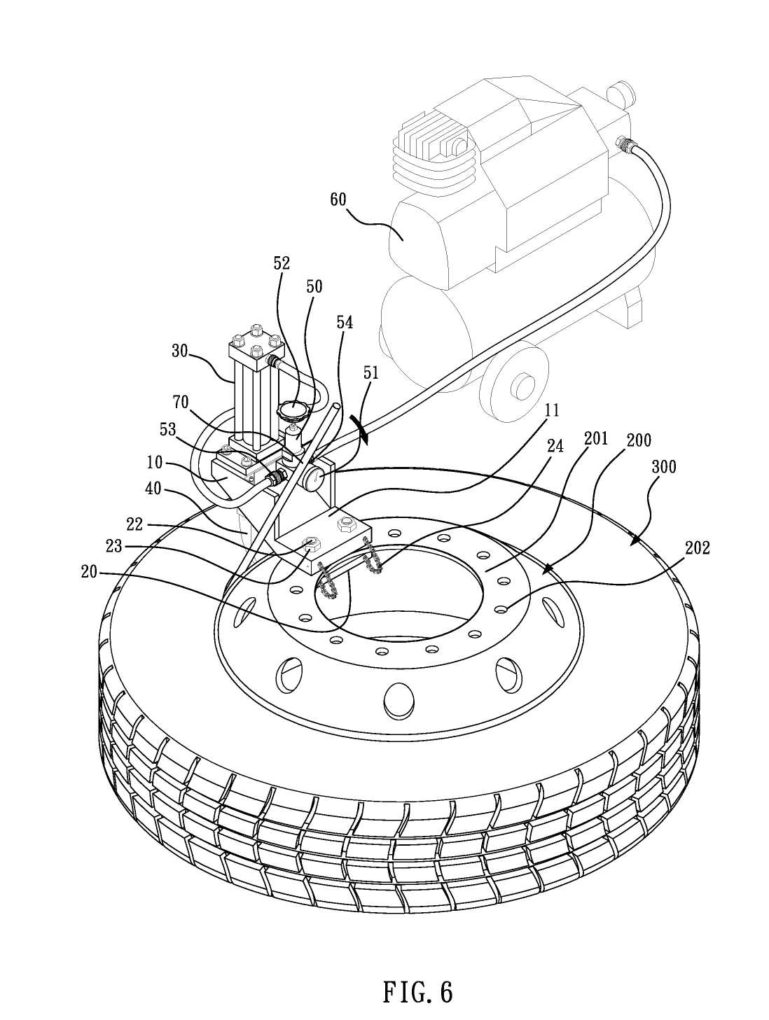

FIG. 5 and FIG. 6 are schematic views illustrating the operation conducted by the tire removing device of the present invention. As the punctured tire 300 is no longer in an internally air-saturated status, with the movement of the power cylinder 30, the tire removing plate 40 is triggered to move toward the inner edge 301 of the tire, so as to push the inner edge 301. Based on the fact that the power cylinder 30 has a certain force output, pushing the inner edge 301 of the tire 300 downward and further away from the outer edge 203 of the wheel rim 200 by use of the tire removing plate 40 is less laborious; an opening A is thus formed between the inner edge 301 of the tire 300 and the outer edge 203 of the wheel rim 200. Next, as shown by FIG. 6, the user is able to insert a strip-shaped wrench 70 into the opening A, so as to prize the tire 300 with the wheel rim 200 as the fulcrum, thereby prizing up the inner edge 301 of the tire 300 over the outer edge 203 of the wheel rim 200. By continuously prizing along the outer edge 203 of the wheel rim 200, the tire 300 is completely removed from the wheel rim 200, facilitating the subsequent tire replacing operation.

Therefore, the tire removing device 100 is relatively small in volume, so as to be carried on the vehicle for meeting user demand in any time. When a tire is punctured, an efficient tire replacing function is immediately provided without the necessity of waiting the roadside assistance offered by the automobile repair shops. Also, during the using recess, the user is able to independently and less laboriously complete the tire replacing operation. As a result, the traffic obstacle is eliminated efficiently, thus preventing the traffic jam from happening.

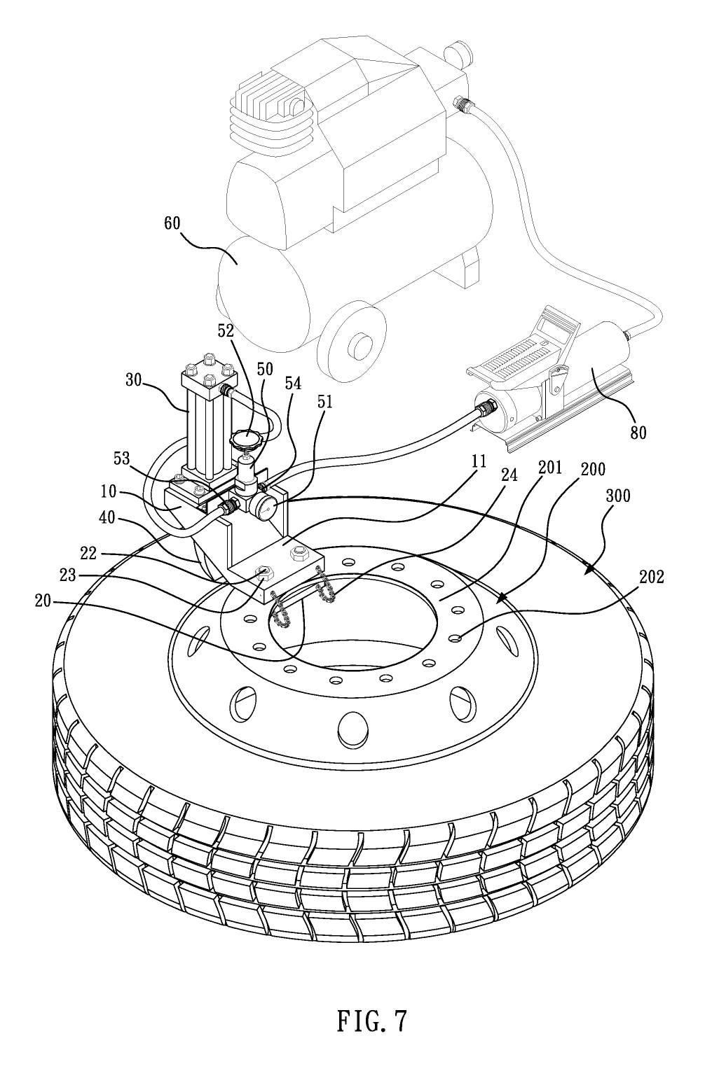

FIG. 7 illustrates another embodiment of the present invention. Mainly, a pressure booster 80 is added between the power source 60 and the pressure adjusting valve 50 for doubling the pneumatic pressure provided by the power source 60. A larger force output is provided to the power cylinder 30. Also, the power cylinder 30 is prevented from unstably boosting the pressure.

To sum up, the tire removing device is small in volume and thus able to be carried. Also, the overall structure is simple, and the cost is relatively low, so as to be an advantageous product in the market. At the same time, the present invention pushes the tire by use of the movement of the power cylinder, whereby the tire is easy to be detached from the wheel rim, such that every vehicle driver is able to replace the tire independently and efficiently eliminate the traffic obstacle caused by tire puncture situation.

Although particular embodiments of the invention have been described in detail for purposes of illustration, various modifications and enhancements may be made without departing from the spirit and scope of the invention. Accordingly, the invention is not to be limited except as by the appended claims.

1. A tire removing device disposed on a wheel rim of a large vehicle for removing a tire, the tire removing device comprising:
a seat provided with a first end and a second end, the first end movably clamping a wheel disk of the wheel rim;
a power cylinder disposed on the second end of the seat and provided with a cylinder body and a moving shaft movable against the cylinder body; and
a tire removable plate connected to an end of the moving shaft,
the tire removable plate pushing an inner edge of the tire when the power cylinder is put in operation, so as to remove the tire from the wheel rim.

2. The tire removing device of claim 1, further comprising a movable plate disposed on the first end of the seat for clamping the wheel disk of the tire.

3. The tire removing device of claim 2, wherein plural screw assemblies are disposed between the movable plate and the seat for passing through the seat, the movable plate, and the wheel disk.

4. The tire removing device of claim 3, wherein each screw assembly comprises a bolt and a nut.

5. The tire removing device of claim 2, wherein a connecting member is disposed between the movable plate and the seat.

6. The tire removing device of claim 5, wherein the connecting member is a chain.

7. The tire removing device of claim 1, wherein the second end is provided with a through hole for the moving shaft to pass through.

8. The tire removing device of claim 1, wherein the tire removing plate is screwedly mounted one the moving shaft.

9. The tire removing device of claim 1, wherein the tire removing plate is provided with an arc end.

10. The tire removing device of claim 1, wherein the first end and the second end are not disposed on a same horizontal plane.

11. The tire removing device of claim 1, wherein the power cylinder is a pneumatic cylinder.

12. The tire removing device of claim 1, further comprising a pressure adjusting valve disposed on the seat and connected to the power cylinder, the pressure adjusting valve connected to a power source and thus controlling strength of a force output of the power cylinder.

13. The tire removing device of claim 12, wherein the pressure adjusting valve is provided with a pressure gauge.

14. The tire removing device of claim 12, wherein the pressure adjusting valve is provided with a pressure adjusting knob.

15. The tire removing device of claim 12, wherein a pressure booster is disposed between the pressure adjusting valve and the power source.
